(19) United States
(12) Patent Application Publication
(10) Pub. No.: US 2014/0126219 A1
(43) Pub. Date: May 8, 2014

(54) Lamp head for decorative light string

(71) Applicant: He Shan Lide Electronic Enterprise Company Ltd., Heshan City (CN)

(72) Inventor: Pong Yang Fan, Heshan City (CN)

(73) Assignee: He Shan Lide Electronic Enterprise Company Ltd., Heshan City (CN)

(21) Appl. No.: 13/987,967

(22) Filed: Sep. 19, 2013

(30) Foreign Application Priority Data
Nov. 7, 2012 (CN) 201220585071.9

(51) Int. Cl. F21V 31/03; F21V 1/00

(52) U.S. Cl. CPC F21V 31/03; F21V 1/00
USPC 362/311.02; 362/311.13

(57) ABSTRACT

A lamp head for decorative light string includes a luminous body, a pair of wires, a lamp base and a lamp shade, the luminous body electrically connected with wires, the lamp base formed by injection moulding and covers part of the packaging body and part of wires and electrode pins that between the packaging body and the wires, the lamp shade is assembled with the lamp base. The lamp base is provided with a plurality of holes, which connect the inner space of the lamp head with the outer space of the lamp head. Thus, water vapor produced in the inner of the lamp head can be expelled freely from the holes, so the decorative light string can remain normal operation to extend its life.

### FIELD OF THE INVENTION

The present invention relates generally to the file of decorative light, and specifically to an injection moulded perforated lamp head for decorative light string.

### BACKGROUND OF THE INVENTION

Decorative lights, which can well decorate and lighten the environment, have become important commodities in people's daily lives. Decorative light string is one of them, which is mainly used for holiday decorations. A decorative light string is composed of a plurality of lamp heads electrically connected to each other by wires, wherein the lamp head generally includes a luminous body, a lamp base used to fix the luminous body, and a lamp shade used to cover the luminous body. The structures of lamp head in the prior art are generally divided into two types: detachable injection moulded structure and nondetachable injection moulded structure. A detachable injection moulded structure is that the lamp base is formed by injection moulding, and the lamp shade and the lamp base can be separated from each other; a nondetachable injection moulded structure is that the lamp base formed by injection moulding, and the lamp shade and the lamp base are inseparable.

Both structures have their advantages and disadvantages. In the detachable injection moulded structure, the lamp shade can be taken off, so it is convenient to repair and replace the lamp shade, or to change lamp shades with different shapes as required. However, there are small gap at the place where the lamp shade and lamp base are joined together. Due to thermal expansion and contraction or other bad environment conditions, water vapor will be formed in the inner space defined by the lamp shade and the lamp base, which accumulates in the inner of the lamp head for a long time, and will seriously affect the normal usage of the decorative light string, bringing problems such as affecting glowing effect, and causing lamp head eroded by water vapor, etc.

In the nondetachable injection moulded structure, the luminous body is connected with wires and placed in the lamp shade, and the tail of the lamp shade formed by injection moulding by an injection moulded process and sealed to form a lamp base, which covers the tail of the lamp shade, the luminous body and part of the wires. The nondetachable injection moulded lamp head structure has an excellent waterproof effect, but it also has some defects, for example, the lamp shade cannot be repaired and replaced, and it also causes water vapor being produced in the inner of the lamp shade when there temperature difference exists between the inner and the exterior of the lamp shade. Due to the sealed structure, water vapor cannot be eliminated, so that it will seriously affect normal usage of the decorative light string.

### SUMMARY OF THE INVENTION

The main object of the invention is to provide a lamp head for decorative light string, wherein water vapor produced in the inner of the lamp head can be expelled to the exterior of the lamp head.

In order to achieve the above purpose, the lamp head of the present invention includes a luminous body, a pair of wires, a lamp base and a lamp shade.

The luminous body includes a luminous chip, two electrode pins and a packaging body; the packaging body covers the chip and part of the electrode pins, and the electrode pins are connected with wires.

The lamp base formed by injection moulding, and it covers part of the packaging body, part of wires and electrode pins between the packaging body and the wires. One side of the lamp base facing the lamp shade is provided with a circular mounting slot, and the lamp shade can be detachably inserted into the circular mounting slot.

The lamp shade is provided with an inner cavity, used for holding a luminous body. After the lamp shade is assembled with the lamp base, the space formed between the lamp shade and the lamp base is the inner space of the lamp head.

The lamp base is provided with a plurality of holes, which connect the inner space of the lamp head with the outer space of the lamp head. Thus, water vapor produced in the inner of the lamp head can be expelled freely from the holes, so the decorative light string can remain normal operation to extend its life.

Other objectives, advantages and novel features of the invention will become more apparent from the following detailed description when taken in conjunction with the accompanying drawings.

### BRIEF DESCRIPTION OF THE DRAWINGS

FIG. 1 shows a schematic view of a light string comprising lamp heads according to an embodiment of the present invention.

FIG. 2 shows an exploded view of a lamp head according to an embodiment of the present invention.

FIG. 3 shows a front section view of a lamp head according to an embodiment of the present invention.

FIG. 4 shows a section view of a lamp shade according to an embodiment of the present invention.

FIG. 5 shows a front section view of a lamp base according to an embodiment of the present invention.

FIG. 6 shows an enlarged view of portion A in FIG. 3.

FIG. 7 shows a lateral section view of a lamp head according to an embodiment of the present invention.

FIG. 8 shows a lateral section view of a lamp base according to an embodiment of the present invention.

FIG. 9 shows an enlarged view of portion B in FIG. 7.

### DETAILED DESCRIPTION OF THE PREFERRED EMBODIMENTS

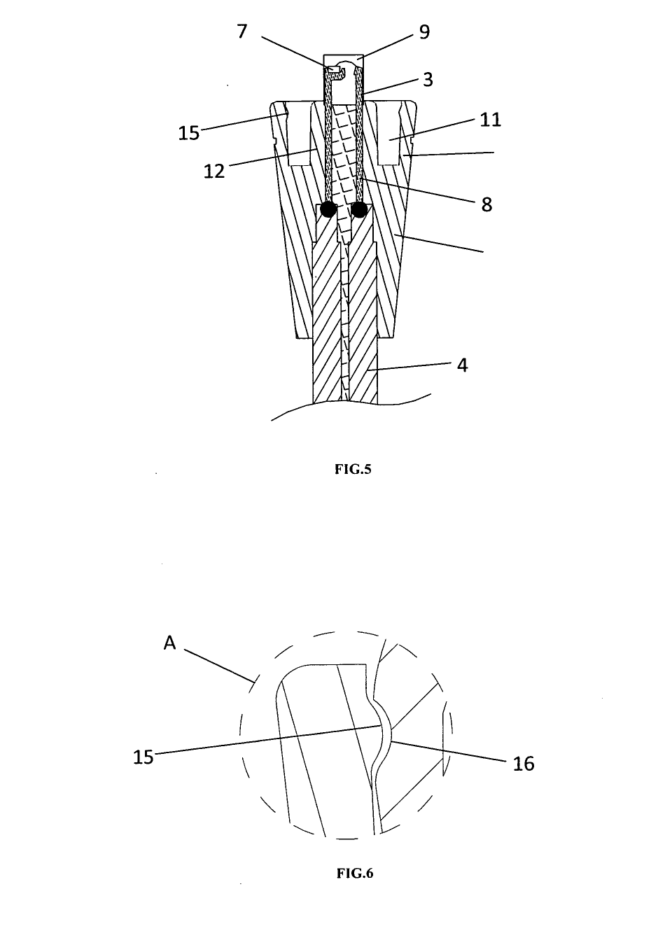

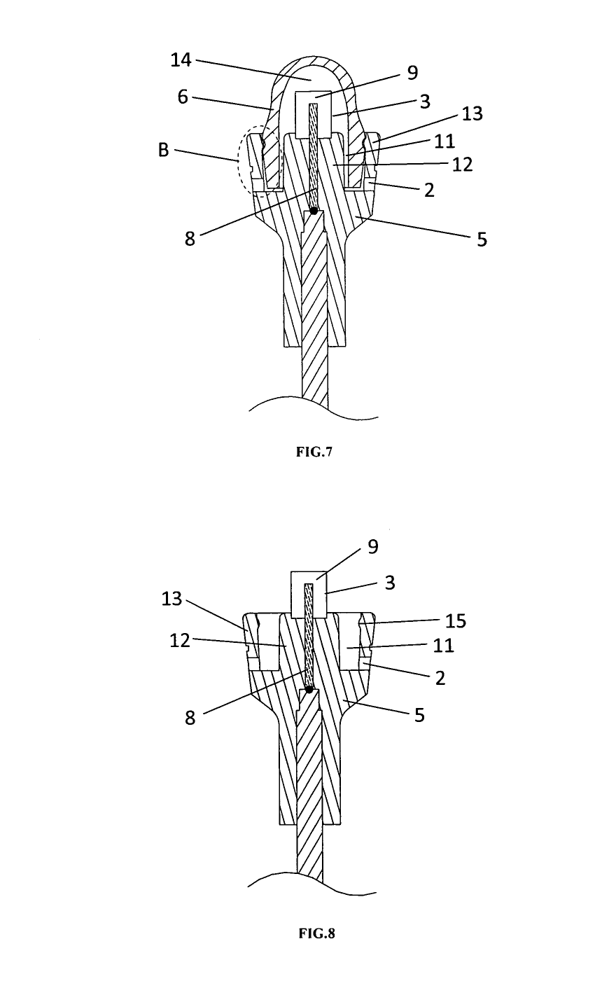

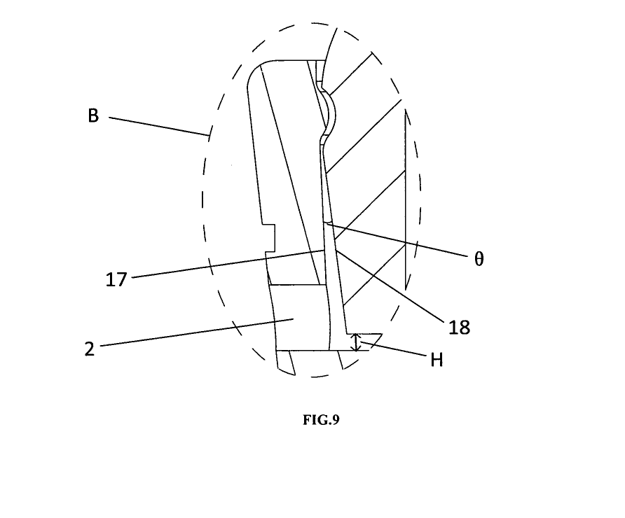

The present invention relates to an injection moulded perforated lamp head (1) for decorative light string. Referring to FIGS. 1-9, a lamp head (1) for decorative light string includes a LED (3), a pair of wires (4), a lamp base (5) and a lamp shade (6).

As shown in FIGS. 3 and 5, LED (3) is a luminous body, which includes a luminous chip (7), two electrode pins (8) and a packaging body (9); the packaging body (9) covers the luminous chip (7) and part of the electrode pins (8), and the electrode pins (8) are electrically connected with wires (4).

The lamp base (5) is formed by injection moulding, which covers part of the packaging body (9), part of wires (4) and electrode pins (8) between the packaging body (9) and the wires (4).

The inner of the lamp shade (6) is provided with an inner cavity (10) configured to hold a LED (3). The lamp shade (6) covers the LED (3) and is fixed onto the lamp base (5), and the connection between the lamp shade (6) and the lamp base (5) is detachable.

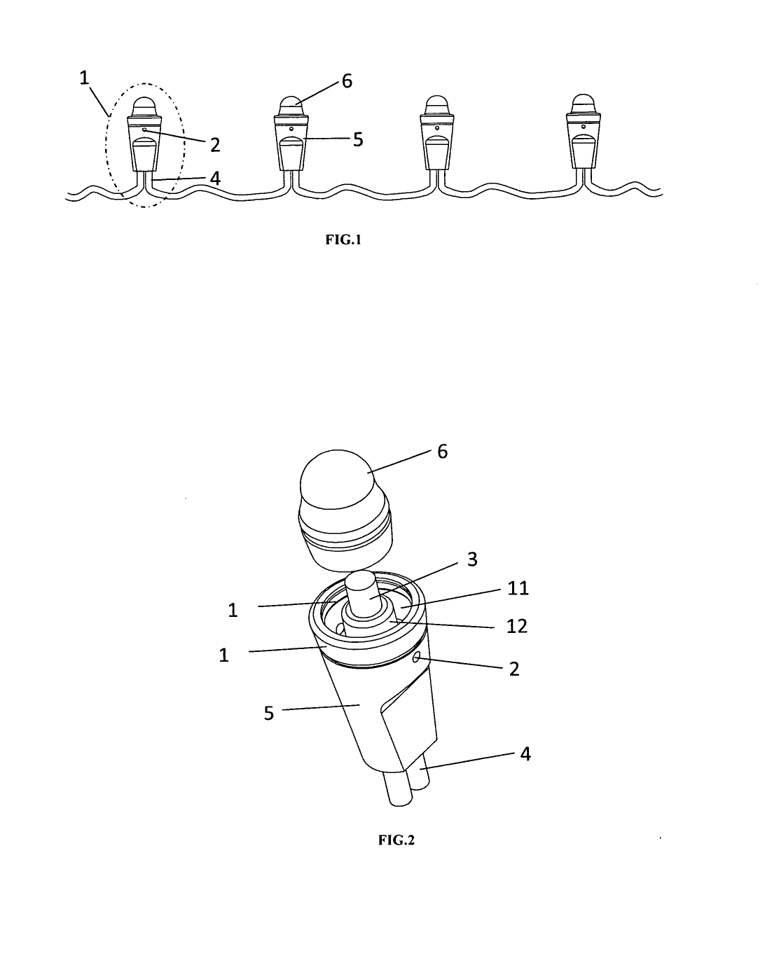

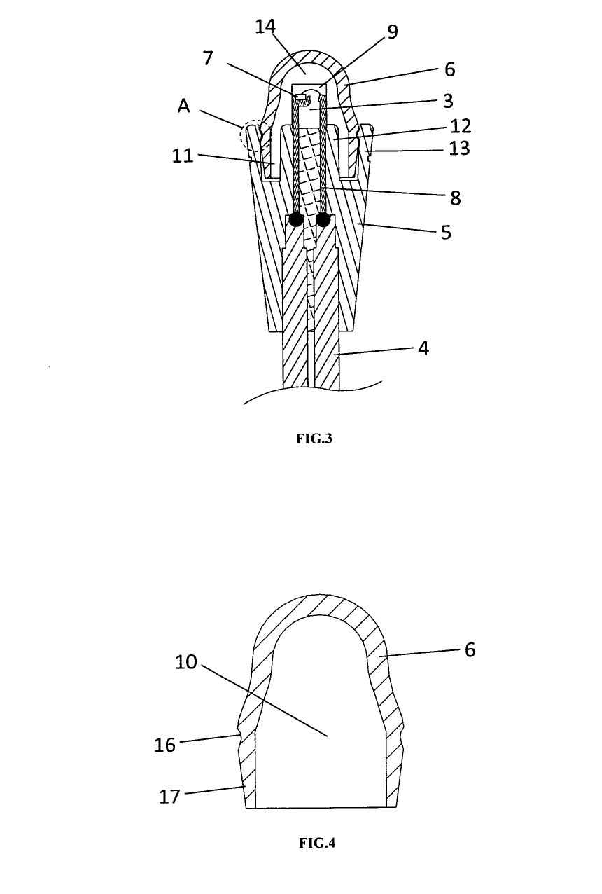

As shown in FIGS. 2 and 3, one side of the lamp base (5) facing the lamp shade (6) is provided with a circular mounting slot (11). A portion of the lamp base (5) that is close to the packaging body (9) of LED (3) is separated by the circular mounting slot (11) to form a LED fixation column (12) and a outer circular wall (13). The LED fixation column (12) covers part of the packaging body (9) of LED (3), so as to achieve the effect of waterproof and insulation of LED (3). The lamp shade (6) is engaged in the circular mounting slot (11). The space formed between the lamp shade (6) and the lamp base (5) is the inner space (14) of the lamp head (1).

As shown in FIGS. 2, 7, 8 and 9, the circular wall (13) of the lamp base (5) is provided with two holes (2) which pass through the circular wall (13) and are tangent to the undersurface of the circular mounting slot (11), so as to connect the inner space (14) of the lamp head (1) with the outer space of the lamp head (1), and is configured to remove water vapor produced in the inner space (14) of the lamp head (1). As shown in FIG. 9, a vertical spatial distance (H) is provided between the undersurface of the lamp shade (6) and the undersurface of the circular mounting slot (11), to facilitating the connection between the inner space (14) of the lamp head (1) with the outer space of the lamp head (1) by the holes (2).

As shown in FIGS. 2-8, the inside surface of the circular wall (13) is provided with a first engagement portion (15) having a convex ring shape, and the periphery of the lamp shade (6) is provided with a second engagement portion (16) having a concave ring shape that matches the first engagement portion (15). The lamp shade (6) can be flexibly engaged into the circular mounting slot (11) of the lamp base (5) by the cooperation between the convex-ring-shaped first engagement portion (15) and the concave-ring-shaped second engagement portion (16).

As shown in FIGS. 3, 4, 7 and 9, the outside surface of the lamp shade (6) placed at the bottom of the concave-ring-shaped second engagement portion (16) is an inclined plane (17), which forms an included angle (0) with the inside surface of the circular wall (13), so as to form a spatial distance to the circular wall (13), which facilitates the connection of the inner space (14) of the lamp head (1) with the outer space of the lamp head (1) by the holes (2), and the removal of water vapor and disassembly of the lamp shade (6).

The invention has the advantage that the lamp base (5) is provided with a plurality of holes (2) which connect the inner space (14) of the lamp head (1) with the outer space of the lamp head (1), so as to help effective removal of water vapor or water in the inner space (14) of the lamp head (1) that due to thermal expansion and contraction or other bad environment conditions.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A lamp head for decorative light string, comprising:
a pair of wires;
a luminous body, which comprise a luminous chip, two electrode pins and a packaging body that covers the luminous chip and part of the electrode pins, the electrode pins electrically connected with the wires;
a lamp base formed by injection moulding process, which covers part of the packaging body, part of wires and electrode pins between the packaging body and the wires; and
a lamp shade, the inner of which is provided with an inner cavity configured to receive the luminous body, wherein the connection between the lamp shade and the lamp base is detachable, and the space between the lamp shade and the lamp base forms an inner space of the lamp head; the lamp base is provided with a plurality of holes which connect the inner space of the lamp head with the outer space of the lamp head.

2. The lamp head for decorative light string of claim 1, wherein the lamp base is provided with two holes.

3. The lamp head for decorative light string of claim 1, wherein one side of the lamp base facing the lamp shade is provided with a circular mounting slot; a portion of the lamp base closing to the luminous body is separated by the circular mounting slot to form a luminous body fixation column and an outer circular wall; the fixation column covers part of the packaging body of the luminous body, and the lamp shade is detachably inserted into the circular mounting slot.

4. The lamp head for decorative light string of claim 3, wherein the holes are provided on the circular wall and passing through the circular wall, so as to connect the inner space of the lamp head with the outer space of the lamp head.

5. The lamp head for decorative light string of claim 4, wherein the holes are tangent to the undersurface of the circular mounting slot.

6. The lamp head for decorative light string of claim 5, wherein a vertical spatial distance is provided between the undersurface of the lamp shade and the undersurface of the circular mounting slot.

7. The lamp head for decorative light string of claim 4, wherein the inside surface of the circular wall of the lamp base is provided with a first engagement portion, and the periphery of the lamp shade is provided with a second engagement portion that matches the first engagement portion; the lamp shade can be flexibly engaged into the circular mounting slot of the lamp base by the cooperation between the first engagement portion and the second engagement portion.

8. The lamp head for decorative light string of claim 7, wherein the first engagement portion of the lamp base is convex-ring-shaped, which surrounds and protrudes from the inside surface of the circular wall, and the second engagement portion of the lamp shade is concave-ring-shaped matching the first engagement portion, which is on the outside surface of the lamp shade.

9. The lamp head for decorative light string of claim 7, wherein the outside surface of the lamp shade placed at the bottom of the concave-ring-shaped second engagement portion is an inclined plane, which forms an included angle with the inside surface of the circular wall.

10. The lamp head for decorative light string of any of claims 1 to 9, wherein the luminous body is a LED.
